(19) United States
(12) Patent Application Publication
(10) Pub. No.: US 2012/0200227 A1
(43) Pub. Date: Aug. 9, 2012

(54) Portable illuminated house and vehicle locating device

(76) Inventor: John R. Nasiatka, Northbrook, IL (US)

(21) Appl. No.: 12/931,511

(22) Filed: Feb. 3, 2011

(51) Int. Cl. H05B 37/02; F21L 4/00

(52) U.S. Cl. 315/159; 362/157; 315/149

(57) ABSTRACT

A portable illuminated device including a resilient plastic hanger and a battery powered LED light source. The plastic hanger allows the device to be placed over the exterior portion of a door lock handle to serve as a visual aid for emergency responders, such as paramedics, responding to a 911 call, to more easily locate the residence that is in need of emergency assistance. And, to allow hanging the device from the supporting member of a vehicle rear view mirror, allowing a person to easily locate their vehicle in a large, dark or unfamiliar parked location.

### BACKGROUND OF THE INVENTION

1. Field of the Invention

The present invention relates to a portable illuminated device that will serve a dual purpose

1. A lighted visual aid for emergency responders, such as paramedics, responding to a 911 call, to more easily locate the residence that is in need of emergency assistance. And

2. To aid a person in establishing the location of an automobile parked in an unfamiliar large outdoor parking facility or garage.

2. Description of the Prior Art

1. When emergency responders, such as paramedics, respond to a 911 call, they are most likely going to a location that they are not very familiar with and must rely upon the street name and house numbers as their guide in identifying the location they are searching for. At night time this can be very difficult as house numbers are not normally lighted and clearly visible, thereby resulting in it taking longer for responders to reach the person requiring assistance. This problem had not received any attention that could be found in searching for patents issued relating to this matter.

When parked in a large, outdoor unfamiliar parking facility such as at a shopping mall, people can experience difficulty in locating their vehicle at that facility after spending some time shopping or engaged in some other time consuming activity. The car may be obstructed from view or the driver simply forgot where they parked the car. When people lose their vehicle, it can be a big inconvenience to everyone concerned. And, it represents a very serious security matter for women and the elderly, since losing their vehicle is most likely to happen at night time when it is dark and bodily injury could occur. The related art is filled with various devices and systems to help solve this problem. From something as simple as placing a colored ball on a projecting car radio antenna, which is no longer available on newer mode cars, to signal flags and associated flagstaff assemblies attached to various structural parts of a car. Such flagging devices not being visible at nighttime when it is most needed. The most sophisticated system uses a remote transmitter and receiver in the car to activate a flashing light and horn when signaled to do so by the remote transmitter. Such systems are very expensive and have generally not performed very well. They are unreliable for many reasons such as transmitter battery failure.

Therefore, there is an urgent need for an inexpensive portable device that can be used for both as a house and vehicle locating device which overcomes the problems associated with all the various known devices in the art.

### SUMMARY OF THE INVENTION

The present invention relates to a series of LED lights in a molded plastic housing having an on/off power control switch, a photo cell for night time operation, a light intensity selection switch (normal or bright), a battery power source. An electronic control system to allow the LED's to be off, constant on, flashing on and returning to the off position. A resilient plastic hanger configured with a hook on one end and a stop form on the opposite end to accept the lighting unit as a snap in place device. With the lighting unit in place on the hanger it can be positioned over the handle of a residential door lock. Or, positioned over the supporting member of a rear view mirror attached to the front windshield of a vehicle. To attract emergency responders to a residence, the device would be turned on to a flashing condition and positioned on the exterior of a residential door lock. The bright light position would be selected which bypasses the photo cell. In this placement the flashing light would be clearly visible and attract the attention of emergency responders approaching the residence. To assist in locating a parked vehicle, the device would be turned on to a flashing condition and positioned over the supporting member of the rear view mirror. During day light the flashing light would remain off by the photo cell sensor detecting light. Or, the photo cell could be bypassed by placing the brightness selector switch in the bright position and the light remains on in a flashing mode allowing a person to easily locate their vehicle in an unfamiliar large outdoor parking facility or garage.

### BRIEF DESCRIPTION OF DRAWINGS

FIG. 1A is a front view of a resilient plastic hanger configured with a hook on one end and a stop form on the opposite end.

FIG. 1B is a side view of the hanger of the present invention with the stop form shown perpendicular to the body of the hanger.

FIG. 2A is a front view of a battery operated lighting unit having a series of LED lights in a molded plastic housing. The transparent front cover has a prism inner surface as in a Fersnel lens, to enhance the brilliance of the LED lights with a smooth outer surface.

FIG. 2B is a side view of the lighting unit showing a photo cell and the brightness selector switch.

FIG. 2C is a bottom view of the lighting unit. A flexible plastic clip is secured to the back and is configured with two (2) projecting V shaped formations at the open end. A power switch extending from the back.

FIG. 3 is a perspective view of the hanger and lighting unit as an assembled device.

FIG. 4 is an enlarged view of the plastic clip with V shaped formations.

FIG. 5 is a perspective view of a handle of a door lock with the present invention positioned on the handle of the door lock.

FIG. 6 is a side section view of a vehicle front windshield with the rear view mirror and support member attached to the windshield and the present invention positioned and secured over the support member.

### DETAILED DESCRIPTION OF THE DRAWINGS

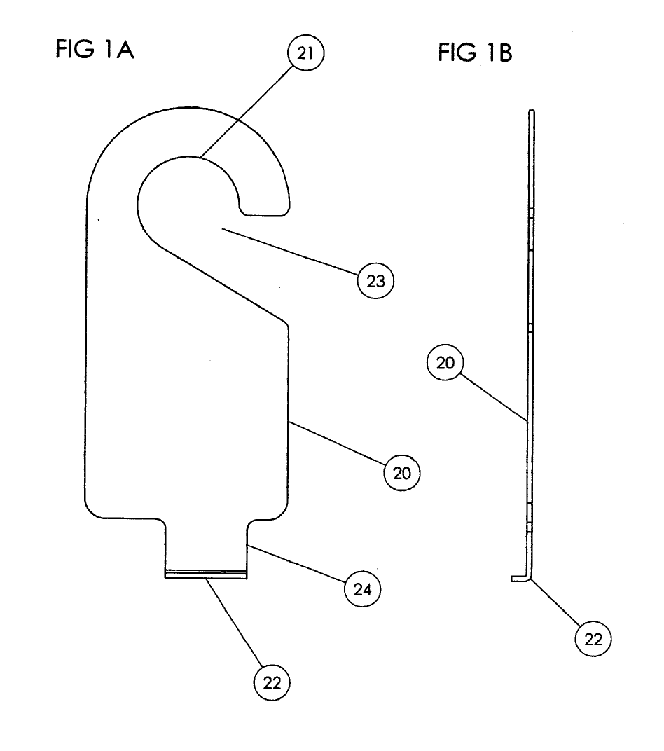

FIGS. 1A and 1B illustrates a front and side view of a resilient plastic hanger in accordance with the invention generally identified with the reference numeral 20. The hanger 20 is formed with circular hook 21 on one end and stop form 22 on the opposite end. The hook formation 21 having a large enough opening 23 to allow it to be placed over and around a door lock handle or over the spindle for a door knob type lock. Edge 24 is used in a cooperative manner to secure the lighting unit to the hanger.

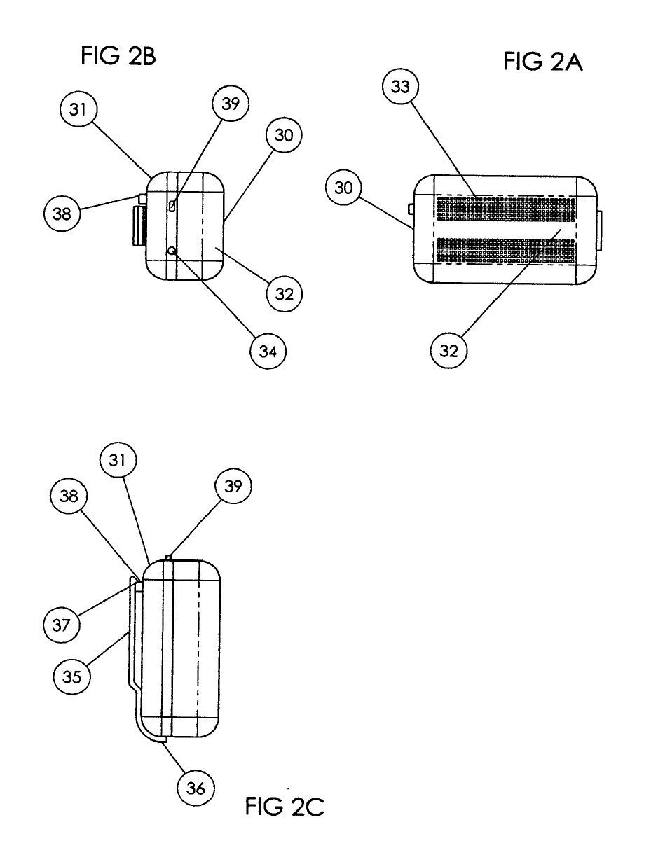

FIG. 2A illustrates a front view of a battery operated lighting unit in accordance with the invention generally identified with the reference numeral 30. Having a series of LED lights enclosed in a plastic housing 31. A transparent front cover 32 having a prism inner surface 33 as in a Fresnel lens, and a smooth outer surface.

FIG. 2B is a side view of the lighting unit 30 with the brightness selector switch 39, the photo electronic cell 34 and the power on/off flashing mode switch 38, shown in their respective positions with case 31.

FIG. 2C is a bottom view of the lighting unit 30. A flexible plastic clip 35 is secured to the plastic cover 31 at location 36. The plastic clip 35 is formed with two (2) V shaped projections 37 that engage the side edge 24 of the hanger 20. When the projections 37 engage with the side edge 24 a locking action occurs securing the lighting unit 30 to the hanger 20. A power on/off flashing mode switch 38 is a projection for easy access by the user. A brightness selector switch 39, normal or bright, is a projection from the plastic case 31 for easy access by the user.

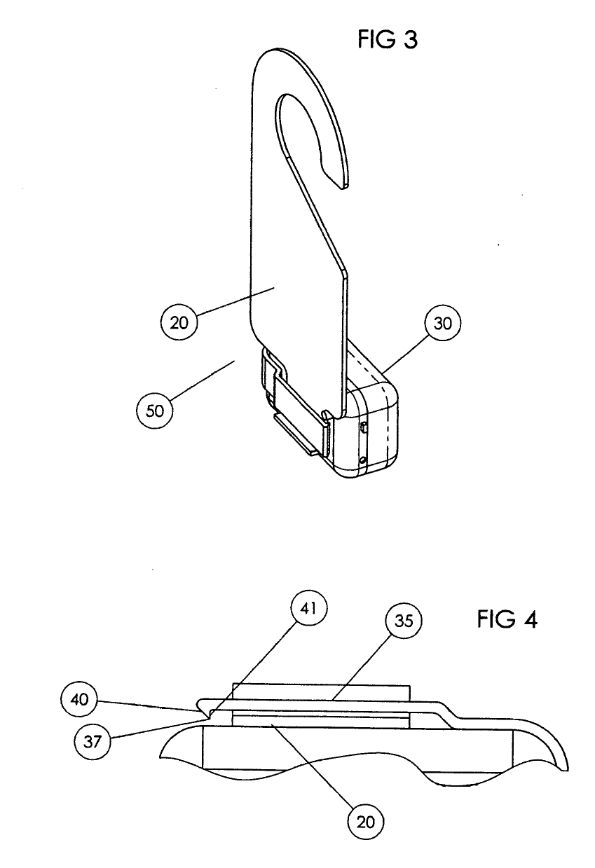

FIG. 3 illustrates a perspective view of the hanger 20 and the lighting unit 30 as an assembled device generally identified with the reference numeral 50.

FIG. 4. is an enlarged view of the flexible plastic clip 35 with the V shaped formations 37 having angled edge 40 and generally perpendicular edge 41 to make engagement with the hanger 20 easy when sliding it into engagement with the hanger 20 and requiring the plastic clip 35 to be flexed back and away from the hanger 20 before it can be removed from the hanger 20, thereby holding it securely engaged with the hanger 20.

FIG. 5 illustrates a perspective view of a door lock handle 45 with the lighting unit assembly 50 in accordance with the present invention placed over the door lock handle 45. The circular hook formation 21 is holding the hanger and lighting unit assembly 50 securely to the door lock handle 45.

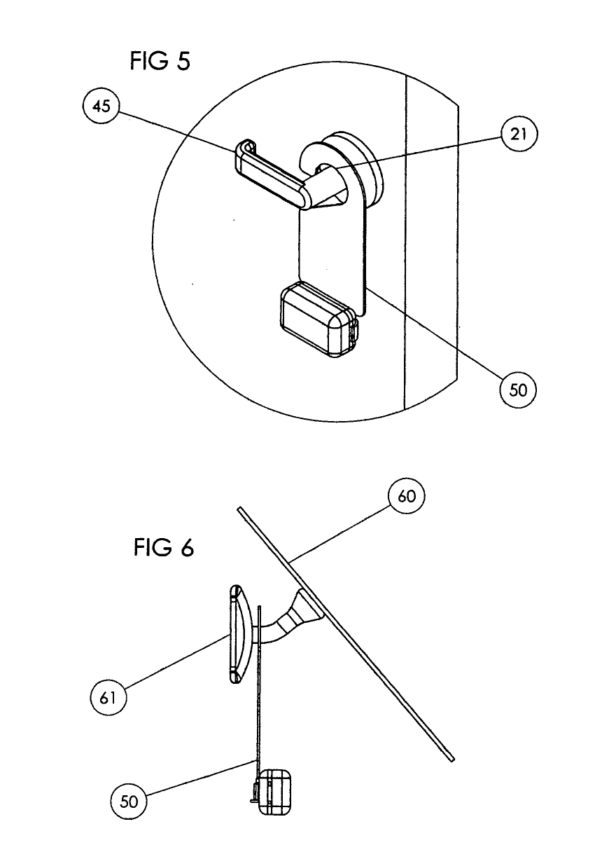

FIG. 6 illustrates a cross section of a vehicle front windshield 60 with the rear view mirror and support member 61 attached to the windshield 60. With the present invention hanger and lighting unit 50 positioned over the support member.

Obviously, many modification and variations of the present invention are possible in light of the above teachings. Therefore, it is to be understood that within the scope of the appended claims, the invention may be appreciated otherwise than as specifically described above what is claimed and desired to be secured by a Letters Patent of the United States is:

I claim:

1. A portable illuminate device comprising: a resilient plastic hanger configured with a hook shape on one end and a stop formation on the opposite end with the stop formation configured to allow the plastic housing of a battery powered lighting unit to be positioned on the resilient plastic hanger and retained to the plastic hanger by a plastic clip.

2. The plastic housing of the battery powered lighting unit according to claim 1 having a clip member for securing the lighting unit to the plastic hanger.

3. The clip member of the battery powered lighting unit as set forth in claim 2 having one or more V shaped formations at the open end.

4. The V shaped formations as set forth in claim 3 having one side perpendicular to the body of the clip with the outer most leading side on an angle.

5. The battery powered lighting unit as set forth in claim 2 having a light sensitive photo cell.

6. The battery powered lighting unit as set forth in claim 2 having a selector switch for normal and bright operation of the light source.

7. The selector switch as set forth in claim 6 configured to bypass the photo cell for power on during daylight conditions.
